(19) United States
(12) Patent Application Publication
(10) Pub. No.: US 2026/0233255 A1
(43) Pub. Date: Aug. 13, 2026

(54) UNLOADING AND SORTING SYSTEM

(71) Applicant: NEXOBOT PTY LTD, Williamstown (AU)

(72) Inventors: Dominic LINDSAY, Altona North (AU); Nicholas HUNT, Moe South (AU)

(21) Appl. No.: 19/156,801

(22) PCT Filed: Feb. 16, 2024
(86) PCT No.: PCT/AU2024/050105

§ 371 Date: Aug. 14, 2025

(30) Foreign Application Priority Data
Feb. 18, 2023 (AU) 2023900411

(51) Int. Cl. B07C 5/36; B07C 3/02

(52) U.S. Cl. CPC B07C 5/36; B07C 3/02; B07C 2501/0063

(57) ABSTRACT

A system (1) for unloading and sorting items (3) transported on one or more autonomous carrier devices (5). The system (1) comprising an elevated platform surface (7) over which the carrier devices (5) travel. The surface having at least one sorting outlet (9) therein. The system (1) further comprises at least one barrier (11) spaced at a height above the surface, the height of the barrier above the surface being high enough to enable the carrier device (5) to travel under the barrier (11) without being impeded, and low enough for at least one item (3) on the carrier device (5) to be pushed off the carrier device (5) by the barrier (11) when the carrier device (5) travels under the barrier (11). The sorting outlet (9) is positioned in the surface such that when an item (3) is pushed off the carrier device (5), the item (3) enters the sorting outlet (9).

### CROSS-REFERENCE TO RELATED APPLICATION

The present application claims priority to Australian Provisional Patent Application No. 2023900411 filed 18 Feb. 2023, the disclosure of which is incorporated herein by reference in its entirety.

### TECHNICAL FIELD

The present disclosure relates to an unloading and sorting system for item(s) on one or more carrier devices.

### BACKGROUND ART

Within the logistics field and other industries there is a need to sort items, for example parcels, into groups sharing a distinguishing quality, characteristic or a common destination. Examples include but are not limited to warehouses, delivery services and library services. Sortation can either be done manually or using automation.

Current automation technologies are typically robotic utilising robotic arms or autonomous mobile robots, or use conveyor-based systems to carry, transport and deliver items to the desired location. They typically use a mechanical system affixed to the carrier device to lift and transfer the carried object to the destination.

An example of an autonomous mobile robotic system is a sorter that utilises a flipper or conveyor on top of an autonomous mobile robot. An issue with known autonomous mobile robot-based item movement, sorting and unloading technologies is the need for a complex mechanical item removal system typically incorporated into the robot itself. These mechanical systems add significant complexity to the platform and weight to the individual robots. The incorporation of this hardware adds significantly to the function of individual robots increasing the quantity of tasks performed by each robot.

It would be desirable to provide a system for unloading and sorting items transported on an autonomous carrier device which has one or more improved features.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### SUMMARY

In accordance with one aspect of the present disclosure, there is provided a system for unloading and sorting items transported on an autonomous carrier device, the system comprising:
a surface over which the carrier device is configured to travel, the surface comprising at least one sorting outlet therein, and
at least one barrier spaced at a height above the surface, the height of the barrier above the surface being high enough to enable the carrier device to travel under the barrier without being impeded, and low enough for at least one item on the carrier device to be pushed off the carrier device by the barrier when the carrier device travels under the barrier,
wherein the at least one sorting outlet is configured to receive the at least one item when it is pushed off the carrier device by the barrier.

The surface may comprise a plurality of spaced sorting outlets, each sorting outlet being positioned adjacent the barrier.

The carrier device may have a track width and the plurality of sorting outlets may each comprise two longitudinal side edges defining therebetween a width of each sorting outlet, the width can be less than the track width of the carrier device such that the carrier device can straddle one of the plurality of sorting outlets when approaching the barrier.

The barrier may be substantially upright and have a planar face for impacting with items, the planar face in one form being disposed substantially perpendicular to the surface.

Each sorting outlet may be aligned relative to the barrier such that the longitudinal side edges of each sorting outlet is perpendicular to a bottom edge of the planar face, the carrier device in one form being configured to travel towards the barrier in general alignment with the longitudinal side edges of one of the sorting outlets such that the item is pushed off a rear end of the carrier device.

The surface over which the carrier device travels may be elevated and each sorting outlet may include a ramp formed between the longitudinal side edges of the sorting outlet, the ramp descending below the surface for transport of the item pushed off the carrier device.

The barrier may be at a height above the surface to enable one or more items to remain on the carrier device and pass underneath the barrier device and one or more items to be impacted by the barrier depending upon the height of the item.

In one form, the system may include a plurality of barriers, each barrier being associated with a corresponding one or more of the plurality of sorting outlets, at least two of the barriers may have a different height to one another thereby enabling items of a certain height to remain on the carrier device and pass underneath one barrier device and be impacted and pushed off the carrier device by the other barrier, thereby enabling items to be dispensed to a particular sorting outlet based upon item height.

The barriers may be mounted on one or more upright support members and be configured to interlock with adjacent barriers.

The surface may be disposed substantially horizontally relative to a ground surface and comprises one or more modular surface elements that connect together to from the surface.

In another aspect of the present disclosure, there is provided a system for unloading and sorting items, the system comprising:
at least one autonomous carrier device for transporting one or more items,
an elevated surface over which the carrier device is configured to travel, the elevated surface comprising at least one sorting outlet therein, and
at least one barrier spaced at a height above the elevated surface, the height of the barrier above the elevated surface being high enough to enable the carrier device to travel under the barrier without being impeded, and low enough for at least one item on the carrier device to be pushed off the carrier device by the barrier when the carrier device travels under the barrier,
wherein the at least one sorting outlet is configured to receive the at least one item when it is pushed off the carrier device by the barrier.

The system may include a plurality of said autonomous carrier devices for transporting items, a plurality of said barriers and a plurality of said sorting outlets, each barrier being associated with a corresponding sorting outlet, each barrier being at a different said height relative to the elevated surface, each autonomous carrier device being configured to travel to a designated sorting outlet and associated barrier deemed suitable for one or more items being carried, the designated sorting outlet and associated barrier for items being carried being determined based upon information on each carried item which is scanned by a scanning device of the system.

In another aspect of the present disclosure, there is provided a method of unloading and sorting items, the method comprising:
moving a carrier device that is configured for transporting one or more items along an elevated surface, the elevated surface comprising at least one sorting outlet therein, and
moving the carrier device towards a barrier, the barrier being spaced at a height above the elevated surface; and
moving the carrier device under the barrier such that at least one of the one or more items impacts the barrier and is pushed off the carrier device by the barrier when the carrier device moves under the barrier, the at least one of the one or more items being received by the at least one sorting outlet.

The elevated surface may comprise a plurality of navigation lines for navigating the carrier device, and the carrier device may comprise at least one sensor configured to locate the navigation line and a processor configured to wirelessly receive navigation instructions and to move the vehicle.

The method may further comprise loading one or more items onto an upper surface of the carrier device.

The method may further comprise providing travel instructions to the processor of the carrier device, the travel instructions including which sorting outlet the carrier device should move towards in order to unload the one or more items disposed on its upper surface.

The step of moving the carrier device towards the barrier may comprise the at least one sensor locating one of the plurality navigation lines that is included in the travel instructions, and the carrier device following that navigation line towards the barrier.

The system and method described is a significant improvement over known arrangements as the means for unloading item(s) is not incorporated into the carrier device, with the system instead utilising the forward momentum of the device to remove the item. This is achieved by travelling underneath the suspended barrier located at the end of the opening in the elevated surface that the carrier device travels over.

### BRIEF DESCRIPTION OF THE DRAWINGS

Various embodiments/aspects of the invention will now be described with reference to the following figures.

FIG. 1A is a perspective view of the system in accordance with one embodiment of the present disclosure illustrating multiple carrier devices on an elevated surface in the various stages of unloading item(s) to sorting outlets;

FIG. 1B is a detailed perspective view of part of the system shown in FIG. 1A illustrating a carrier device passing over a sorting outlet on approach to a barrier;

FIG. 2 is an rear end view of a carrier device shown on the right in FIG. 1B passing over a sorting outlet on approach to the barrier, the barrier being positioned at a height to allow the carrier device to travel below the barrier while keeping the item being transported in place prior to impact with the barrier and subsequent unloading to the sorting outlet below;

FIG. 3 is a detailed perspective view of the sorting outlet on the left in FIG. 1B illustrating an item almost fully removed from a carrier device after impact with the barrier, the item being partially on the ramp of the sorting outlet in the elevated surface;

FIG. 4 is a detailed perspective view part of the system shown in FIG. 1A illustrating an item on the ramp of a sorting outlet after having passed through the opening in the elevated surface;

FIGS. 5A to 5F are schematic diagrams of the operational steps taken by a single carrier device using three lines to navigate to a sorting outlet, and

FIGS. 6A to 6F are schematic diagrams of the operational steps taken by a carrier device traveling to a sorting outlet when there are multiple carrier devices present.

### DETAILED DESCRIPTION OF EMBODIMENTS

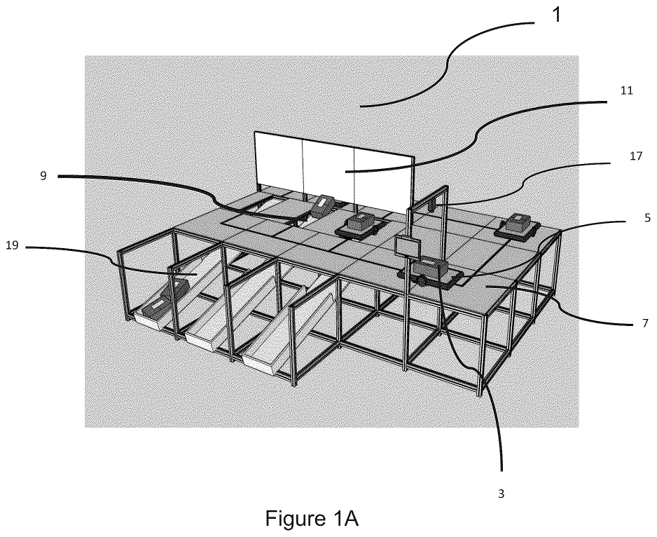

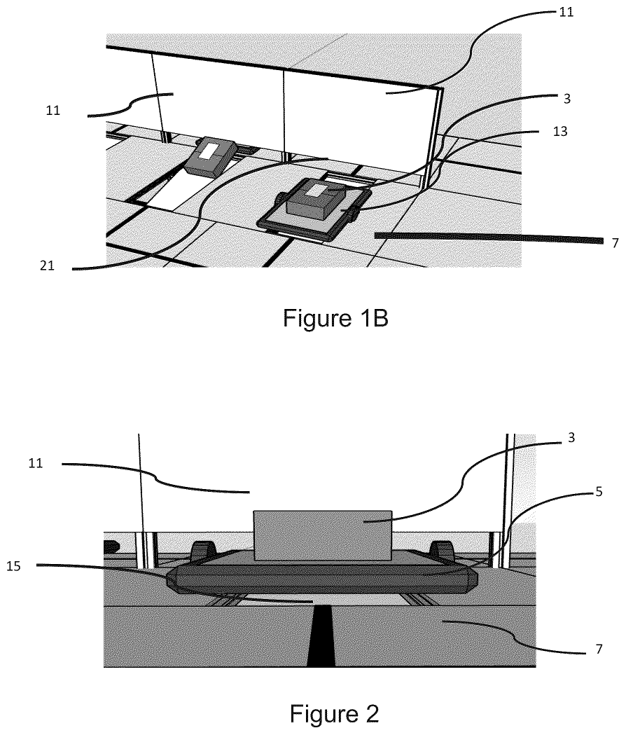

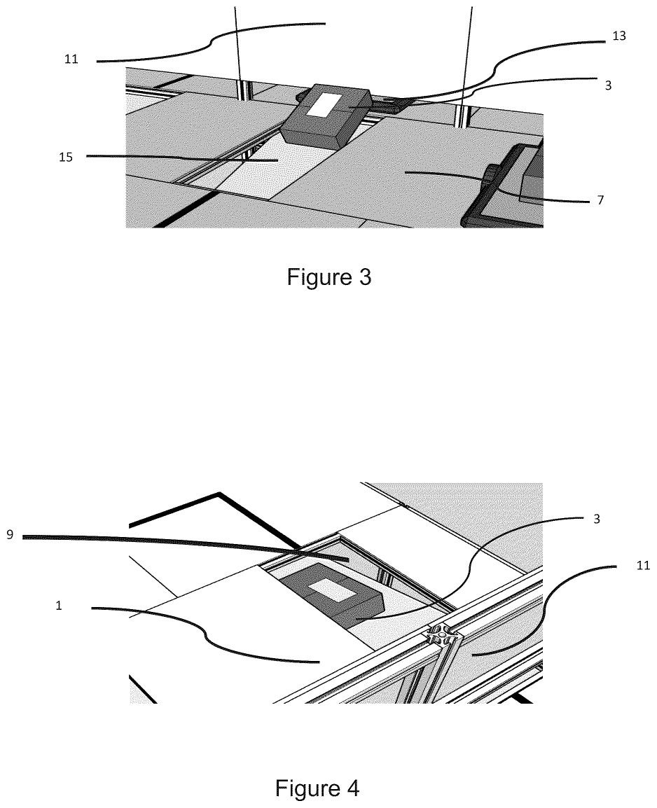

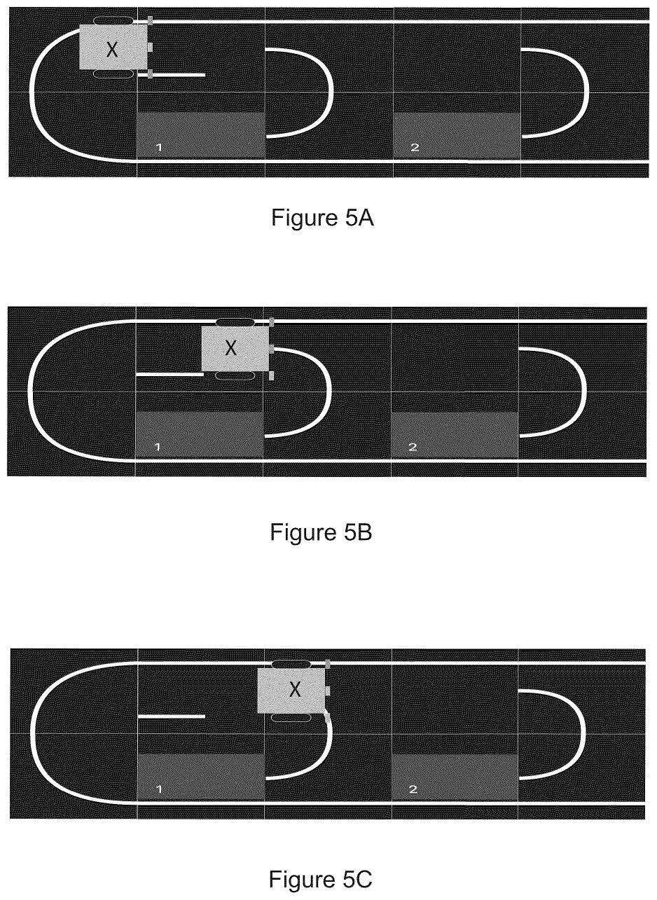

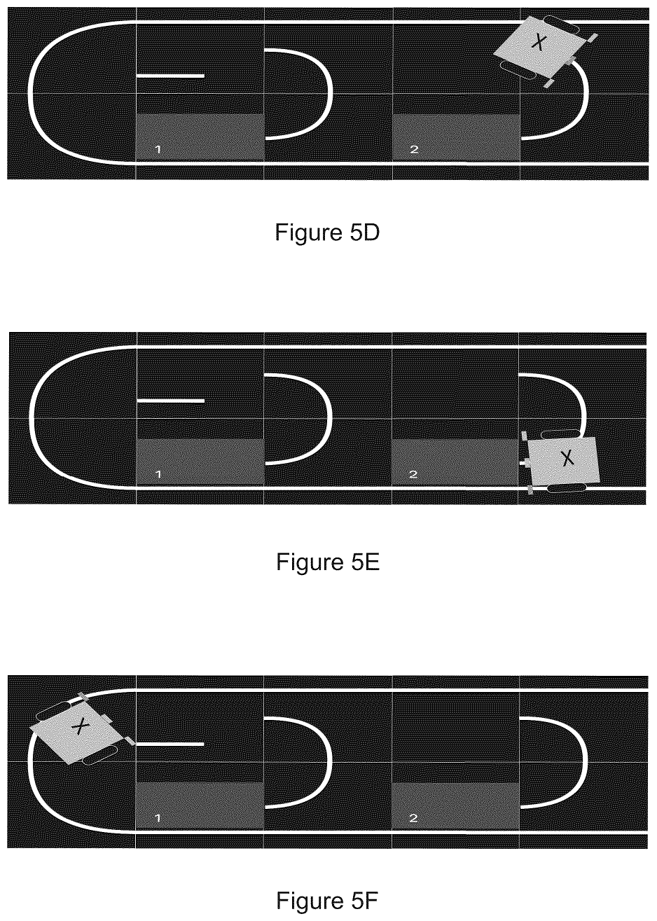

With reference to FIGS. 1A to 4, there is disclosed a system 1 for unloading and sorting items 3, for example parcels, transported on one or more autonomous carrier devices 5, for example robots. The system 1 includes a surface, which may be in the form of an elevated table or platform, over which each carrier device 5 is configured to travel to deposit one or more items 3 being carried to designated sorting outlets 9 provided in the surface. The surface may be horizontally orientated and comprise one or more modular surface elements 7 which connect together to from the surface. The overall layout of the table surface does not need to be specifically as shown in FIG. 1A, other table layouts could be used to achieve the same effect. The system 1 also includes one or more stationary barriers 11 positioned above the surface at a height such that there is a gap between the surface and each barrier 11 which is sufficient for at least some of the carrier devices 5 to pass through without being impacted by the barrier. The height of each barrier 11 is also low enough such that at least one item 3 provided on a planar payload surface 13 of a carrier device 5 is impacted by the barrier 11 and pushed off the carrier device 5 when the carrier device 5 passes under a barrier 11, as illustrated in FIG. 2. Each barrier 11 is substantially upright and has a planar face oriented perpendicular to the surface 7 for impacting with items 3. In another embodiment, the carrier device 5 may have one or more containers into which the item(s) may be placed. The container(s) may connect into place and be displaced upon impact by the barrier 11. For example, the container may click into place on the carrier device 5 and only be removed by impact in one direction. The container(s) then fall into the sorting outlet 9 rather than the items themselves.

Each sorting outlet 9 includes an opening or hole in the surface 7 which is preferably positioned immediately in front of a corresponding barrier 11. The opening may for example be rectangular in shape and be generally aligned with respect to the barrier 11 such that longitudinal side edges of the opening are perpendicular to a bottom edge 21 of barrier 11. In another embodiment, the opening could be to either side of the barrier 11, with the barrier 11 angled in such a way to push the item 3 to the side, rather than the back of the carrier device 5. Each sorting outlet may also include a ramp 15 which descends below the surface along which items 3 pushed off the carrier device 5 may slide to a designated storage area. In another embodiment, the ramp 15 may be substituted for a conveyor belt which is stationary when the carrier device 5 moves over it and under the barrier, then moves as soon as the carrier device 5 has past.

As best illustrated in FIGS. 1B and 2, each carrier device 5 preferably has a track width that is greater than the width of the sorting outlets 9 such that each carrier device 5 is able to pass over the sorting outlets 9 on approach to a barrier 11 without falling through or becoming stuck on the sorting outlet 9. In this respect, each carrier device 5 in one embodiment may have at least one wheel on either side of the carrier device 5 to straddle the sorting outlet 9 on approach to the barrier 11. In another embodiment, the wheels of the carrier device 5 may travel along a rail track provided on the surface. In yet another embodiment, the carrier device 5 may be suspended from an overhead rail system. Each carrier device 5 preferably travels towards the barriers 11 in general alignment with the longitudinal side edges of the sorting outlet 9, as illustrated in FIG. 1A, such that the item(s) 3 are pushed and thereby unloaded off the back of the carrier device 5 as the carrier device 5 passes under the barrier 11. The unloaded item(s) may then slide down the ramp 15 and onto a sorting chute 19 where items 3 may accumulate at the end of the chute 19, as illustrated in FIG. 1A. In another embodiment, the barrier 11 may have motorised wheels to push the item on the carrier device 5 to the left or right, rather and impacting the item 3 with direct contact.

A multiple number of carrier devices 5, barriers 11 and sorting outlets 9 may be provided. In this respect, multiple barriers 11 may be aligned in a row and interlocked with adjacent barriers by upright support members. In another embodiment, the barriers 11 may be separate and arranged one behind the other along with each associated sorting outlet 9. The system 1 may also be fully modular and include multiple sized carrier devices 5 and have customizable elevated surface configurations to suit different item types. Each barrier 11 may be at a different height to the surface to cater for items and/or carrier devices of different sizes. For example, a barrier 11 may be suspended at a level to enable smaller height objects to pass underneath and to block larger objects. More specifically, a carrier device 5 may for example approach a first barrier 11 positioned at a height to provide a 100 mm gap between the barrier 11 and the surface. The device 5, may for example be carrying a first item 3 having a height of 50 mm and a second item 3 having a height of 200 mm. The second item 3 would be blocked by the first barrier 11 and fall into the associated first sorting outlet 9, while the first item 3 would remain on the carrier device 5. The first item 3 having a height 50 mm can then be blocked by a second barrier positioned behind the first barrier 11, the second barrier 11 being for example positioned at a height to provide only a 30 mm gap between the second barrier 11 and the surface. The first item 3 thereby impacts the second barrier 11 and is pushed off the carrier device 5 into a second sorting outlet 9 associated with the second barrier 11. This process enables larger items to be readily separated from smaller items which is advantageous in determining which transportation method to use. For example, the larger items collected from the first sorting outlet 9 may for example be then transported on pallets as their larger dimension justifies the expense of stacking the items onto a pallet, while the smaller items collected from the second outlet 9 may be transported effectively in bags.

The sortation process begins by placing one or more items 3, for example parcels, directly on a carrier device 5 at an induction point. The carrier device 5 may in one embodiment then proceed to a scanning location where an overhead scanner 17 can capture a barcode on the item. In another embodiment, an image can be captured and the dimensions of the item calculated. Once scanned a web application can be used to match the barcode to a sort point, otherwise known as a sorting outlet 9, and communicates travel instructions to the carrier device 5. The carrier device 5 then proceeds to the sort outlet. In the detailed embodiment, the carrier device 5 does not stop while moving and preferably uses a line tracking sensor at the front of the carrier device 5 to maintain its course. The carrier device 5 is able to identify and navigate the path required to reach the designated sort outlet whilst avoiding other carrier devices 5 on the same platform. In one embodiment, navigation is based on navigation lines provided on the surface being traversed. In other embodiments, navigation can be camera or radio wave based. The carrier device 5 will travel over the opening provided by the designated sorting outlet 9 in the elevated surface. If the carrier device 5 is a wheeled carrier device as illustrated in FIGS. 1A to 4, its wheels are disposed on either side of the opening enabling transit over the sorting outlet 9. The carrier device 5 then passes under the associated barrier 11 suspended over the surface. As the carrier device 5 passes below the barrier 11, the item 3 onboard gently slides off the back of the carrier device 5 and onto a ramp 15 which may lead to a sorting chute 19. Items 3 may then accumulate at the end of the chute 19 as illustrated in FIG. 1A. The carrier device 5 then navigates back to a return position in readiness for the next item.

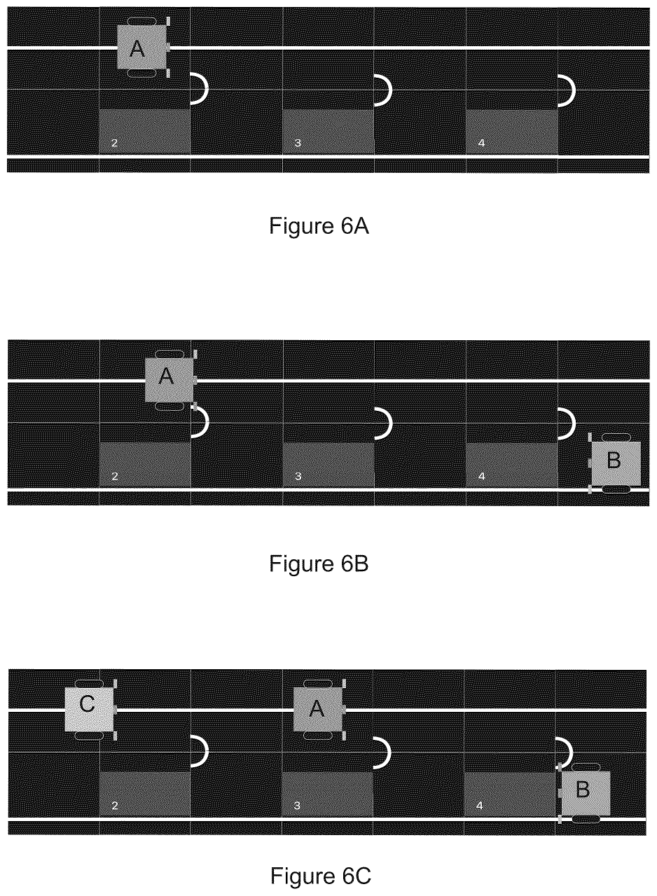

FIGS. 5A to 5F are schematic diagrams of the operational steps in navigating a single carrier device to a sorting outlet/point using lines to navigate. In FIG. 5A, carrier device X is initially in a “returning” state. When a right side sensor of carrier device X senses a right side navigation line, carrier device X will change to a “ready for item” state. One or more items will then be loaded onto carrier device X. Once the designated sorting outlet has been determined, carrier device X is provided with required travel instructions and carrier device X will change to an ‘outbound’ state and follow the left side navigation line. In FIG. 5B, carrier device X will progress until the middle sensor detects a line, then a variable sort points passed value will increment by 1 and will be compared with a sort point required value. If sort points passed<sort point required value, carrier device X will continue as in FIG. 5C. Once sort points passed equals sort point required, carrier device X will change to a ‘crossing’ state, as shown in FIG. 5D, and then begin to drive following the right side navigation line. When the left side sensor of carrier device X detects the left side navigation line, as shown in FIG. 5E, carrier device X will transition to a ‘sorting’ state and will begin to drive following the left line sensor. After unloading at the second sorting outlet, carrier device X continues to a return location shown in FIG. 5F in which the right side sensor detects the right side navigation line.

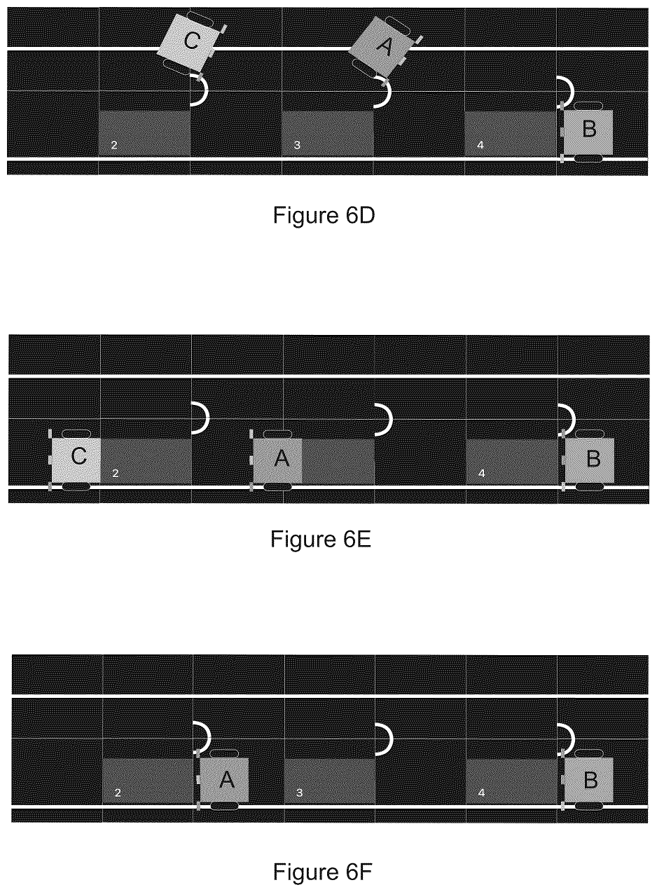

FIGS. 6A to 6F are schematic diagrams of the operational steps taken by a carrier device in navigating to a sorting outlet when multiple carrier devices are present. In FIG. 6A, carrier device A is travelling to sort point 3. As carrier device A in FIG. 6B starts crossing the sort point prior to its destination, ie sort point 2, it starts alerting all other carrier devices on the network that it's about to cross sort point 3. It does this by increasing the ‘traffic’ count at sort point 3. Carrier device B is shown in FIG. 6B on its return journey having unloaded it's item at a sort point beyond sort point 4. In FIG. 6C, carrier device B has reached sort point 4 on its return journey. Carrier device B knows that there's traffic on sort point 3, so it stops and waits. Carrier device B is only free to pass when the ‘traffic’ count at sort point 3 is zero. In FIGS. 6D and 6E, carrier device C crosses over to sort point 2 and carrier device A crosses over to sort point 3, while carrier device B keeps waiting until it receives the all clear or a predetermined length of time has passed. In FIG. 6F, as carrier device A on its return journey recognises that it's passing sort point 2, it signals to all other carrier devices that there is one less ‘traffic’ amount on sort point 3. Carrier device B receives the new ‘traffic’ amount for sort point 3, which is zero. This enable carrier device B to continue. Both carrier devices return safely, with minimal disruptions to outbound traffic.

The system disclosed advantageously enables carrier devices to use their forward momentum to unload items such as parcels, eliminating the need for a mechanical unloading mechanism. The system advantageously offers a low cost automated sortation solution.

The word ‘comprising’ and forms of the word ‘comprising’ as used in this description and in the claims does not limit the invention claimed to exclude any variants or additions.

Modifications and improvements to the invention will be readily apparent to those skilled in the art. Such modifications and improvements are intended to be within the scope of this invention.

1. A system for unloading and sorting items transported on an autonomous carrier device, the system comprising:
a surface over which the carrier device is configured to travel, the surface comprising at least one sorting outlet therein, and
at least one barrier spaced at a height above the surface, the height of the barrier above the surface being high enough to enable the entire carrier device to travel under the barrier without being impeded, and low enough for at least one item on the carrier device to be pushed off the carrier device by the barrier when the carrier device travels under the barrier,
wherein the at least one sorting outlet includes an opening in the surface which is positioned in front of the barrier, the carrier device being configured to pass over the opening on approach to the barrier without falling through or becoming stuck, the sorting outlet being configured to receive the at least one item when it is pushed off the carrier device by the barrier as the carrier device travels under the barrier.

2. The system as claimed in claim 1 wherein the surface comprises a plurality of spaced sorting outlets, each sorting outlet being positioned adjacent the barrier.

3. The system as claimed in claim 2 wherein the carrier device has a track width and the plurality of sorting outlets each comprise two longitudinal side edges defining therebetween a width of each sorting outlet, the width being less than the track width of the carrier device such that the carrier device can straddle one of the plurality of sorting outlets when approaching the barrier.

4. The system as claimed in claim 3 wherein the barrier is substantially upright and has a planar face for impacting with said items, the planar face being disposed substantially perpendicular to the surface.

5. The system as claimed in claim 4 wherein each sorting outlet is aligned relative to the barrier such that the longitudinal side edges of each sorting outlet is perpendicular to a bottom edge of the planar face, the carrier device being configured to travel towards the barrier in general alignment with the longitudinal side edges of one of the plurality of sorting outlets such that the item is pushed off a rear end of the carrier device.

6. The system as claimed in claim 4 wherein the surface over which the carrier device travels is elevated and each sorting outlet includes a ramp disposed between the longitudinal side edges of the sorting outlet, the ramp descending below the surface for transport of the item pushed off the carrier device.

7. The system as claimed in claim 1, wherein the barrier is at a height above the surface to enable one or more items to remain on the carrier device and pass underneath the barrier device and one or more items to be impacted by the barrier.

8. The system as claimed in claim 2, wherein the system comprises a plurality of barriers, each barrier being associated with a corresponding one or more of the plurality of sorting outlets, at least two of the barriers having a different height to one another thereby enabling items of a certain height to remain on the carrier device and pass underneath one barrier device and be impacted and pushed off the carrier device by the other barrier, thereby enabling items to be dispensed to a particular sorting outlet based upon item height.

9. The system as claimed in claim 8 wherein the barriers are mounted on one or more upright support members and are configured to interlock with adjacent barriers.

10. The system as claimed in claim 8 wherein the barriers are arranged one behind the other along with each associated sorting outlet.

11. The system as claimed in claim 1 wherein the surface is disposed substantially horizontally relative to a ground surface, and comprises one or more modular surface elements that connect together to from the surface.

12. A system for unloading and sorting items, the system comprising:
at least one autonomous carrier device for transporting one or more items,
an elevated surface over which the carrier device is configured to travel, the elevated surface comprising at least one sorting outlet therein, and
at least one barrier spaced at a height above the elevated surface, the height of the barrier above the elevated surface being high enough to enable the entire carrier device to travel under the barrier without being impeded, and low enough for at least one item on the carrier device to be pushed off the carrier device by the barrier when the carrier device travels under the barrier,
wherein the at least one sorting outlet includes an opening in the surface which is positioned in front of the barrier, the carrier device being configured to pass over the opening on approach to the barrier without falling through or becoming stuck, the sorting outlet being configured to receive the at least one item when it is pushed off the carrier device by the barrier as the carrier device travels under the barrier.

13. The system as claimed in claim 12 wherein the system includes a plurality of said autonomous carrier devices for transporting items, a plurality of said barriers and a plurality of said sorting outlets, each barrier being associated with a corresponding sorting outlet, each barrier being at a different said height relative to the elevated surface, each autonomous carrier device being configured to travel to a designated sorting outlet and associated barrier deemed suitable for one or more items being carried, the designated sorting outlet and associated barrier for items being carried being determined based upon information on each carried item which is scanned by a scanning device of the system.

14. A method of unloading and sorting items, the method comprising:
moving a carrier device that is configured for transporting one or more items along an elevated surface, the elevated surface comprising at least one sorting outlet therein having an opening in the elevated surface;
moving the carrier device over the sorting outlet and towards a barrier, the sorting outlet being positioned in front of the barrier, the carrier device being configured to pass over the opening in the elevated surface without falling through or becoming stuck; and
moving the carrier device under the barrier, the barrier being spaced at a height above the elevated surface which is high enough to enable the entire carrier device to travel under the barrier without being impeded and low enough such that at least one of the one or more items impacts the barrier and is pushed off the carrier device by the barrier as the carrier device moves under the barrier, the at least one of the one or more items being received by the at least one sorting outlet.

15. A method according to claim 14, wherein the elevated surface comprises a plurality of navigation lines for navigating the carrier device, and the carrier device comprising at least one sensor configured to locate the navigation line and a processor configured to wirelessly receive navigation instructions and to move the vehicle.

16. A method according to claim 15, further comprising loading one or more items onto an upper surface of the carrier device.

17. A method according to claim 16, further comprising providing travel instructions to the processor of the carrier device, the travel instructions including which sorting outlet the carrier device should move towards in order to unload the one or more items disposed on its upper surface.

18. A method according to claim 17, wherein moving the carrier device towards the barrier comprises the at least one sensor locating one of the plurality navigation lines that is included in the travel instructions, and the carrier device following that navigation line towards the barrier.
